(19) United States
(12) Patent Application Publication
(10) Pub. No.: US 2010/0134690 A1
(43) Pub. Date: Jun. 3, 2010

(54) Television receiver

(75) Inventors: Akinori Tsubouchi, Takarazuka (JP); Kenichi Iwamoto, Sakurai (JP); Hiroki Gakumura, Kobe (JP)

Correspondence Address: MASUVALLEY & PARTNERS, 8765 AERO DRIVE, SUITE 312, SAN DIEGO, CA, 92123, US

(73) Assignee: Sanyo Electric Co., Ltd., Moriguchi (JP)

(21) Appl. No.: 12/315,545

(22) Filed: Dec. 3, 2008

(51) Int. Cl. H04N 5/57; H04N 5/63

(52) U.S. Cl. 348/687; 348/730; 348/790; 348/E05.001; 348/E05.119; 348/E05.127

(57) ABSTRACT

The present invention is a television receiver, including a counter which measures a time period for which the television receiver continuously operates, an evaluator which determines whether the time period is more than a predetermined time period and a controller which adjusts a brightness value of a picture to more than a predetermined value when the time period is more than the predetermined time period.

### TECHNICAL FIELD

The present invention relates to a television receiver and other electronic appliances that automatically shift into an exhibition mode when being continuously operated for a predetermined time.

### BACKGROUND OF THE INVENTION

In view of environment protection in recent years, television receivers are required to set in a lower power consumption when shipping the television receivers. Further, the television receiver is in a power saving setting suitable for viewing by setting the brightness of a picture (brightness value and lightness value) lower for normal use so that a consumer does not feel too bright when the television receiver is in the possession of the consumer and used in a household. In this way, the picture of television receiver is normally in a setting not too bright for consumers, thus there has been a problem that television receiver does not appeal to the consumers because the consumers feel that the picture is dark when the television receiver is exhibited in a store. Further, in a case when a competitor's television receiver is in a brighter setting for storefront exhibition, the television receiver was giving an inferior impression to consumers comparing to the competitor's television receiver. In order to respond to such issues, a storefront mode, in which brightness value and lightness value are set to higher values than the normal, or the color saturation is set to a higher value, is applied to the television receiver when it is exhibited in storefront. Further, in order to install the television receivers in an appropriate condition according the situation in each store, changing the sound setting of the television receiver etc. has been performed. However, a special operation is required to switch a conventional television receiver into a storefront mode, and employees of stores have been manually performing these switching operation when exhibiting the television receiver in the store. Because the switching operation must be conducted by the store employees, there have been problems where the television receiver is often exhibited in a store without being switched to the storefront mode when the store employees forget the switching operation. As a result, consumers were given the impression that a manufacturer's own television receiver is inferior to the television receivers of competitors that have the same capability. Meanwhile, because the storefront mode can only be canceled manually in a case when the merchandise exhibited in a store is sold to a consumer, there are many cases where the store employees forget to cancel the storefront mode and the television receiver still in the storefront mode is passed to the consumer. As a result, there have been cases where the purchasers of the television receiver complained. Under these circumstances, a number of retailers have been hoping for a television receiver that can solve problems described above.

### SUMMARY OF THE INVENTION

One aspect of the present invention may be a television receiver, including a counter which measures a time period for which the television receiver continuously operates, an evaluator which determines whether the time period is more than a predetermined time period and a controller which adjusts a brightness value of a picture to more than a predetermined value when the time period is more than the predetermined time period.

By configuring as described above, the television receiver is automatically set to an appropriate setting for an exhibition without performing a manual setting when the television receiver is exhibited. Therefore, it can save the efforts of setting conventionally performed by a store clerk or a manager and also the television receiver can be set to the exhibition mode automatically even when the store clerk etc. forgets to perform the appropriated mode setting for an exhibition. As a result, the problem of giving an inferior impression to consumers compared to other products due to the television receiver, which has been exhibited without performing the setting to the exhibition mode, can be resolved.

The brightness value may be adjusted to not less than 450 cd/m² when a size of the television receiver is not less than 24 inches. The brightness value may be adjusted to not less than 250 cd/m² when a size of the television receiver is less than 24 inches. By setting the television receiver to the brightness value, more beautiful and bright picture can be provided to viewers in a store or exhibition site.

The brightness value of the picture may be adjusted to a brightness value, which is suitable for an exhibition.

The television receiver further may include a liquid crystal display having a backlighting device, wherein the ON mode power level of the backlighting device is not more than 391 W when a size of the liquid crystal display is not more than 60 inches. The backlighting device may be a light emitting diode or a cold cathode fluorescent lamp. By setting the ON-mode power level of the backlighting device to the value mentioned above, more beautiful and bright picture can be provided to a viewer in a store or exhibition site.

The counter may start measuring the time period when the television receiver is turned on and may stop measuring the time period when the television receiver is turned off. The counter may reset the time period when the television receiver is turned off. The predetermined time period may be 48 hours. The predetermined time may be 36 hours.

Another aspect of the present invention may be a television receiver including a measuring device which counts a power consumption of the television receiver while the television receiver continuously operates and an adjuster which automatically raises a brightness value of a picture when the power consumption is more than a predetermined value.

By configuring the television receiver as described above, the television receiver is automatically set to the appropriate setting for an exhibition without performing manual setting when the television receiver is exhibited. Therefore, it can save the effort of setting conventionally performed by a store clerk or manager and also the television receiver can be set to the exhibition mode automatically even when the store clerk etc. forgets to set to the mode appropriate for an exhibition. As a result, the problem of giving an inferior impression to consumer compared to other products due to the television receiver, which is exhibited without being set to the exhibition mode can be resolved.

The adjuster may convert a condition of the television receiver into a condition, which is suitable for an exhibition. The adjuster may convert a sound level of the television receiver into a sound level, which is adequate for exhibition condition. The adjuster may limit the setting range of the television receiver within which a setting of the television receiver can be changed.

By configuring the television receiver as described above, the television receiver may be set to a condition according to an atmosphere or situation of a store or exhibition site.

Another aspect of the present invention may be a method of adjusting a setting of a television receiver, including the steps of counting a time period within which the television receiver is continuously turned on and determining whether a brightness value of a picture is adjusted or not according to the time period.

By configuring the television receiver as described above, the television receiver is automatically set to the setting appropriate for an exhibition without performing manual setting when the television receiver is exhibited. Therefore, it can save the efforts of setting conventionally performed by a store clerk or manager and also the television receiver can be automatically set to the exhibition mode even when the store clerk etc. forgets to set to the mode appropriate for an exhibition. As a result, the problem of giving an inferior impression to consumers compared to other products due to the television receiver, which is exhibited without being set to the exhibition mode, can be resolved.

The brightness value may resume to a setting condition prior to the step of adjusting when the television receiver is turned on again after being turned off. By configuring the television receiver as described above, the television receiver with the setting appropriate for an exhibition returns to a setting before making the adjustment when the power of the television receiver is turned off and there is no need to cancel the setting for an exhibition even in a case when the television receiver which is exhibited in a store is sold. Thus it eliminates the efforts for performing the setting. Further, in a case when a purchaser accidentally set the television receiver to the exhibition setting at home etc., the purchaser can easily return the television receiver to the normal mode by turning the power off.

The number of possible items for adjusting setting of the television receiver including the brightness value may be limited once the brightness value has been adjusted. By configuring the television receiver as described above, change of the setting for the television receiver by a sales representative from a competitor etc. can be prevented.

The brightness value may automatically resume to the setting condition in which the brightness value was adjusted when the brightness value is changed after having determined that the brightness value has been adjusted. By configuring as described above, the brightness value of the picture automatically returns to the exhibition setting even in a case when the setting of television receiver is changed by a sales representative of a competitor etc from the setting suitable for an exhibition. Thus, the television receiver does not give bad impression to consumers.

The brightness value may be adjusted to not less than 450 cd/m² when a size of the television receiver is not less than 24 inches. The brightness value may be adjusted to not less than 250 cd/m² when a size of the television receiver is less than 24 inches.

### BRIEF DESCRIPTION OF THE DRAWINGS

FIG. 1 is a block diagram illustrating an example of a television receiver of the present invention.

FIG. 2 is a remote controller used to remotely-control a television receiver of the present invention.

FIG. 3 is a diagram showing an overall configuration of a television receiver of the present invention.

FIG. 4 is a flow chart illustrating an example of an operating pattern of a television receiver of the present invention.

FIG. 5 is a flow chart illustrating an example of an operating pattern of a television receiver of the present invention.

FIG. 6 is a flow chart illustrating an example of an operating pattern of a television receiver of the present invention

FIG. 7 is a diagram comparing a television receiver set to a suitable mode for store display to a television receiver at shipping.

### DETAILED DESCRIPTION OF INVENTION

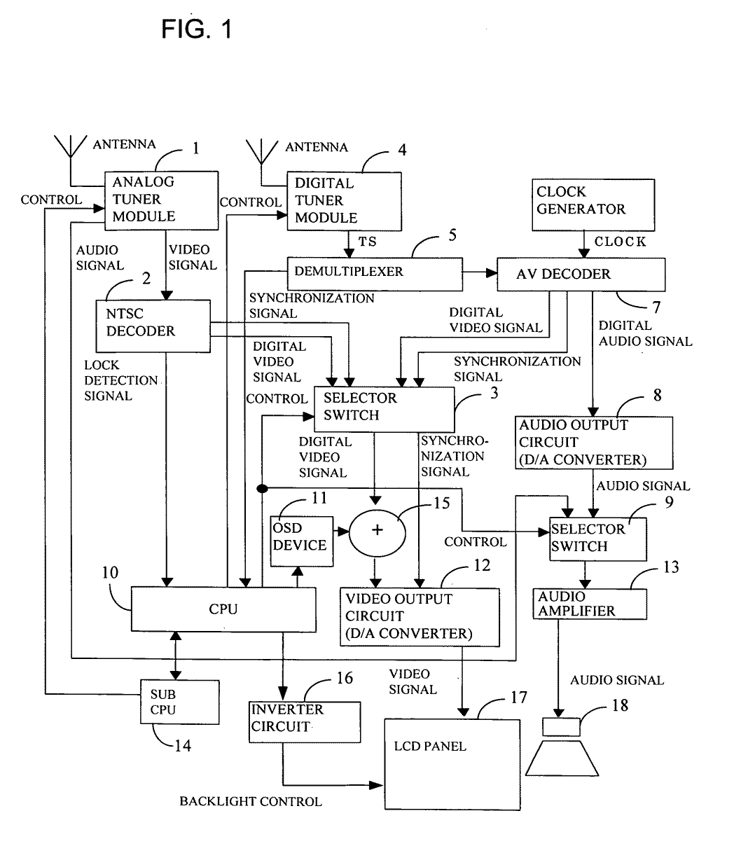

FIG. 1 is a block diagram illustrating a television receiver 35 capable of receiving an analog broadcast and digital broadcast.

A digital antenna is arranged outdoor facing to a predetermined direction, and receives a digital broadcast signal and gives it to a digital tuner. Further, an analog antenna receives an analog signal and gives it to an analog tuner 1.

The digital tuner 4 picks up a signal with a specific frequency from a high-frequency digital modulated signal containing visual/audio data. Further, by having a demodulation circuit, reverse interleave circuit, error correction circuit and etc., the digital tuner 4 outputs a transport stream by demodulating the selected digital modulated signal.

A demultiplexer (DEMUX) 5 inputs a transport stream from the tuner 4 based on an instruction of a CPU 10, and separates it into a video steam of MPEG2 (Moving Picture Experts Group 2), audio stream and PSI/SI (Program Specific Information/Service Information) being adjunct information. The demultiplexer 5 selects video/audio stream of a digital broadcast from the instruction of the CPU 10, supplies them to a AV decoder 7 and supplies a program information contained in the PSI/SI (ex. name of the program, starting time of the program, duration of the program, contents information of the program, genre information of the program) to the CPU 10. The analog tuner 1 picks up an audio signal and video signal from the signal received from the antenna. The video signal that is picked up is transmitted to a NTSC decoder 2. The audio signal that is picked up is outputted from a speaker 18 through an audio amplifier 13 after transmitted to a selector switch 9.

The AV decoder 7 is provided with a video decoder for decoding a video stream and an audio decoder for decoding an audio stream. The video decoder decodes the inputted variable-length code to obtain a quantized coefficient or a motion vector, and performs a motion-compensated control etc. based on a reverse-DCT conversion or the motion vector. The audio decoder decodes the inputted code signal to generate an audio data. The video data generated by decoding is outputted to a video output circuit 12 through a selector switch 3 and the audio data is outputted to the audio output circuit 8.

The video output circuit 12 receives the video data and performs D/A (digital/analog) conversion to convert the video data into a composite video signal, for example. The audio output circuit 8 receives the audio data outputted from the AV decoder 7 and performs D/A conversion, to generate an analog signal of right (R) sound and left (L) sound and an analog signal of main sound and sub sound.

Further, the video output circuit 12 and audio output circuit 8 are provided with an output resistance or amplifier etc. The AV output terminal that receives a signal from the video output circuit 12 and audio output circuit 8 is provided with an output section (a set of left/right audio output terminals or a video output terminal), and a TV tube 17 or speaker 18 is connected to this output section through a video/audio code. In addition, the audio signal from the audio output circuit 8 is converted into a sound by being transmitted to the speaker 18 after the audio signal has been transmitted to the audio amplifier 13 through the selector switch 9.

An OSD (on-screen display) device 11 generates a video data based on the character information or color information outputted and instructed from the CPU and outputs the data to an adder 15. The adder performs a process to incorporate the video data into the received video data outputted from the AV decoder 7. This OSD device 11 can display an electronic program guide, menu screen and various setting screens (channel setting screen etc.).

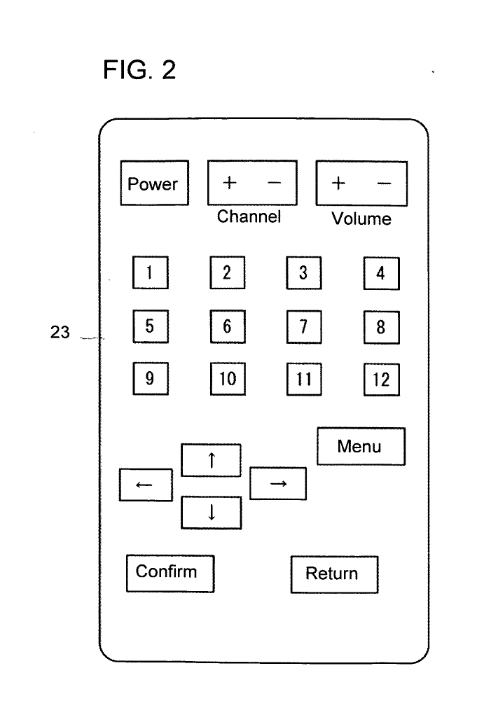

A remote transmitter (remote controller) 23 is provided with various keys as shown in FIG. 2 to transmit various instructions to the television receiver 35. When operating the key, a signal light (remote control signal) which is an instruction corresponding to that key, is transmitted from a light emitting section. A SUBCPU 14 receives the signal light, converts this into an electric signal, and transmits it to the CPU 10. The SUBCPU 14 operates as a controller for a television receiver. For example, it is used to control a stand-by state of a television receiver, or acts as a remote control receiver. The Inverter Circuit 16 transmits the signal received from CPU 10 to LCD panel 17, and plays a role of converting the direct current to the alternating current.

In a memory (for example, RAM, EEPROM, and a flash memory etc.) (not shown), a channel information (frequency information, information such as a channel list corresponding to a number key) and various setting information are stored in addition to the information (program information) for displaying EPG (electronic program guide) screen.

The CPU 10 is to perform overall control of this digital television receiver 35. Particularly, as the processes related to the present invention, channel information obtaining process, channel preset setting, channel skip setting and channel selection process or setting process etc. corresponding to the key operation of the remote control transmitter 23 are performed.

The television receiver pertaining to the present invention has been explained with concrete examples. However, the present invention is not limited to the subject related to the concrete example. The television receiver pertaining to the present invention includes a CRT-television receiver, a liquid crystal television receiver, a plasma television receiver, a projection television receiver, a video projector, and an organic EL (Electro-Luminescence) television receiver. Further, the types of components in the television receiver and their locations are not limited, and may be anything as long as a picture is shown in a display. Further, the television receiver is not necessarily having a remote control transmitter in the embodiment described above, and the television receiver may have a remote control transmitter in a different embodiment, or may not have remote control transmitter at all.

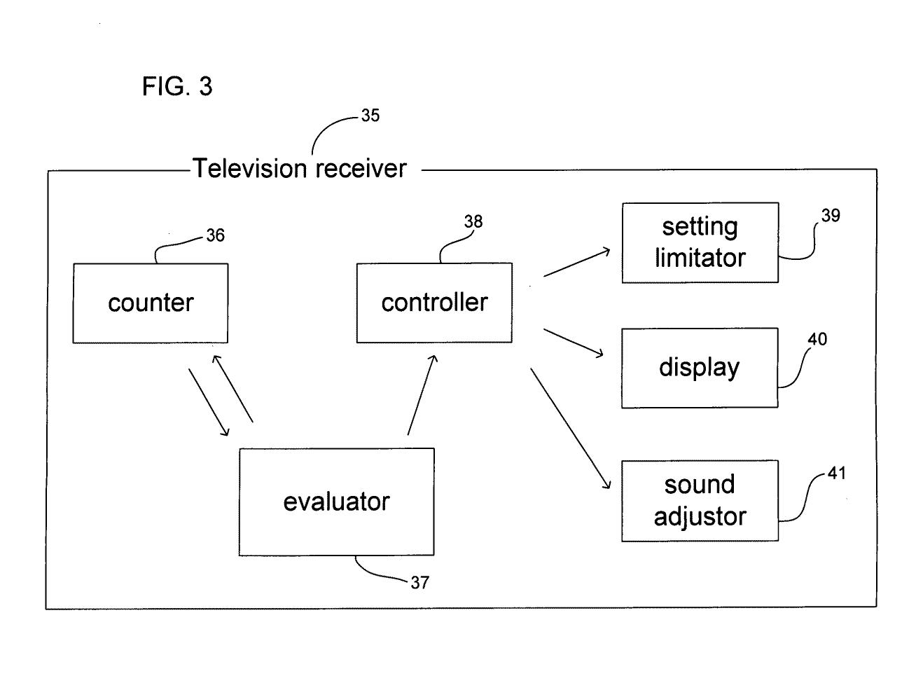

The features of the present invention will be explained concretely with reference to FIGS. 3 to 6. Concretely, the television receiver pertaining to the present invention firstly measures the duration in which the television receiver is continuously operating, after the power of the television receiver is turned on. A predetermined time is stored in a memory of the television receiver, and determinations are made whether the duration for the continuous operation of the television receiver exceeds the stored time or not for a number of times with the elapse of time. And in a case when the measured time exceeds the time stored in the memory, the setting of the television receiver is changed to a setting suitable for exhibition (hereinafter referred as exhibition mode).

For example, as the setting suitable for exhibition, following items 1) to 5) may be considered. (1) In a case when exhibiting the television receiver, brightness, lightness, and color saturation of picture higher or the brightness of the back light are set higher than the case of using the television receiver at home. Generally, when a television receiver is exhibited in a store, consumers feel darker comparing to using at home. Thus, it can be said that setting the picture brighter in a store etc. is a suitable setting for exhibition.

(2) To change the setting of audio output from the television receiver to a setting appropriate for an exhibition. For example, it is effective for sale promotion to match the exhibition conditions of the television receivers to the condition of each store and it can be said that it is more appropriate setting for the exhibition. Concretely, for example, the sound outputted from the television receiver is set relatively high when there are electronic products output relatively loud sounds around the television receiver. On the other hand, setting the sound output from the television receiver relative low is a setting suitable for an exhibition when the electronic products, which do not output sound, or output minimum sound, are arranged around the television receiver.

(3) To limit the items that can be adjusted for the television receiver. As the items, there are listed to disable external adjustment of the brightness, lightness and color saturation of the display of the television receiver, and to disable to externally adjust the picture of the display to deteriorate it. To avoid intentional adjustment by a sale representative of a competitor or consumer etc. when the television receiver is exhibited, it is a suitable setting to limit the range within which the menu setting of the television receiver can be changed. Here, the intentional picture adjustment refers to, for example, adjustments to deteriorate the picture, to unnecessarily increase the brightness of the picture, and to change the setting to a picture that is difficult to view etc.

(4) To configure the setting to return to the setting suitable for an exhibition after a predetermined time is elapsed in a case when the setting of the television receiver is changed externally during the exhibition mode. To avoid intentional adjustment by a sale representative of a competitor or consumer etc. when the television receiver is exhibited, it is suitable to set the television receiver as described above. Here, the predetermined time may be few minutes or several tens of minutes.

(5) To set the picture quality of the television receiver to an appropriate value. For example, setting the brightness, lightness and color saturation of the picture of the television receiver to the appropriate values can be considered. Here, for example, this includes setting the brightness, lightness and color saturation of the picture of the television receiver to lower values so that the consumer can easily view.

Next, a configuration of the television receiver pertaining to the present invention is hereinafter explained. FIG. 3 is a diagram illustrating an overall configuration of the television receiver pertaining to the present invention. A television receiver 35 is formed from a counter 36, a judgment unit 37, and a controller 38. The counter 36 functions to measure the time. The counter 36 may start and finish measuring time at any time. For example, the counter 36 may start measuring time when the power of the television receiver turned on, or when the television receiver starts operation. Further, the counter 36 may start measuring the time when a setting is made to the television receiver, or the predetermined time has elapsed after turning on the power of the television receiver.

Further, the timing when the counter 36 finishes measuring time may be when, for example, the power of the television receiver turned off, or a predetermined operation has been made. When the counter 36 finishes measuring time by turning off the power of the television receiver, normally the measured time is reset and the value returned to zero. And, when the power of the television receiver is turned back on, the counter 36 is set to start measuring the time again.

The time data measured by the counter 36 is transmitted to the judgment unit 37 in a predetermined time interval according to an instruction of a CPU (not shown). When receiving the time data, the judgment unit 37 compares the received time data to a preset time data stored in the memory. In a case when the received time is longer than the preset time, an instruction data to switch the setting of the television receiver to the exhibition mode is transmitted to the controller 38 according to an instruction of the CPU. And, in a case when the received time is shorter than the preset time, the judgment unit 37 does not operate and stands by while waiting for new time data to be transmitted from the counter 36. In addition, the preset time is not particularly limited and may be any length, such as about 24 hours, 36 hours, and 48 hours; however, it is preferable to set to the time that is not normally watched in a household. In addition, there are many cases where the television receiver is continually operated over 24 hours because the number of stores in 24-hours operation is increasing.

When the controller 38 receives the instruction data to switch the setting of the television receiver to the exhibition mode, the controller 38 switches various settings to the settings suitable for exhibition. The setting suitable for exhibition is the settings described in 1) to 5) above. The television receiver may be provided with any components other than the components 36 to 38, and, for example, a setting limitator 39, display 40 and sound adjustor 41 etc. may be provided.

The setting limitator 39 functions to limit menu items that can be set externally for the television receiver according to an instruction from the controller 38. The display 40 functions to set the brightness, luminosity, and color saturation of the picture quality to appropriate values according to the instruction from the controller 38. Because the television receiver is normally exhibited at storefront etc., the brightness of the picture is preferably set to the value sufficient for the storefront display of the display of the television receiver. Meanwhile, it is effective to set the display brighter for the storefront display comparing to the television receiver normally used in a household; however, it works other way if the display is too bright. Thus the brightness of the picture is preferably set in a degree that the display of the television receiver is not too dark for storefront display.

The television receiver may be divided into a medium-large size and small size. For example, the medium-large size can be not less than 24 inches, or 24 to 52 inches. And, the small size can be less than 24 inches, or to 23.9 inches, for example. When the television receiver is for personal use, such as in a household use, generally the brightness value is set to about 300 cd/m² for mid-large size. Meanwhile, the brightness value is generally set to about 200 cd/m² for small size. Also, it can be said that the brightness value is generally decreased about 20% of maxim value when the television receiver is used for a household.

It can be said that the brightness value for the television receiver suitable for storefront display is higher comparing to those used in a household described above. Concretely, the brightness value is preferably about not less than 400 cd/m² for the mid-large size television receiver, and more preferably about not less than 450. In case the size of the television receiver is small, the brightness value of the television receiver is preferably about not less than 250 cd/m².

To provide the brightness of the picture suitable for an exhibition, the back light of the television receiver (e.g. liquid crystal television etc.) may be adjusted to emit sufficient brightness. As an index to indicate the brightness of the backlight suitable for an exhibition, the power consumption of the backlight can be considered. For example, the on-mode power level of the television receiver suitable for an exhibition may be as shown in the table below.

TABLE 1

| Size of television receiver | |
|---|---|
| (Inch) | On-mode power level (W) |
| 20 inches | 66 W or below |
| 32 inches | 120 W or below |
| 42 inches | 208 W or below |
| 50 inches | 318 W or below |
| 60 inches | 391 W or below |

Normally, a cold cathode fluorescent lamp (CFL), and light emitting diode (LED) etc. are used as a light source for back lighting of a liquid crystal television. The power consumption suitable for an exhibition may be adjusted as needed for the cases when the cold cathode fluorescent lamp is used and when the light emitting diode is used.

Meanwhile, the sound adjustor 41 provided in the television receiver functions to adjust the volume and the quality of the sound outputted from the television receiver according to the instruction from the controller 38. The sound adjustor 41 is capable of adjusting the sound to the level that is sufficient for the exhibition of the television receiver. It is effective to arbitrarily set the volume and the quality of the sound according to the noise level in a store or arrangement of appliances in the store.

As described above, for example, the counter 36 measures the time when the television receiver is in operation. However, the counter 36 may measure the power consumed by the television receiver. The power consumption is calculated by multiplying the power by time, thereby the power consumption in a certain period is integrated. And, the power consumption for a predetermined period (for example, one day, one month or one year) which is prescribed in advance, is stored in the memory of the television receiver, and the controller 38 may operate and perform the change of setting as described a when the judgment unit 37 determines that the measured power consumption exceeds the power consumption stored in the memory.

In addition, the television receiver pertaining to the present invention is not necessarily to be provided with the counter 36, judgment unit 37, controller, 38 as components, and for example, the television receiver is not provided with a component (for example, judgment unit 37) and another component may function as the lacking component. That is, there may be a processor functions as the counter 36, the judgment unit 37, and the controller 38 described above.

In addition, the television receiver pertaining to the present invention is turned on in a shipping state without having any setting when the power of the television receiver is turned on for the first time. However, once the power is turned on, the television receiver turns on in a setting state right before turning the power off thereafter. When the power is turned off after the television receiver is once transitioned to an exhibition mode, the television receiver is turned on in a setting state right before transitioned into the exhibition mode. By designing the television receiver in this way, the television receiver can easily be returned to a setting for a household use by a consumer turning off the television receiver even when the television receiver is transitioned to the exhibition mode because of the consumer having watched the television for unusually long time after purchasing the television receiver. Further, even in a case when a store clerk forgets to cancel the setting to transition to the exhibition mode at the time of sale of the television receiver, the television receiver can be returned to a setting for a household when a consumer turns the power off.

In addition, when the power is turned on again after the power of the television receiver in the exhibition mode is turned off, the television receiver may be designed to turn on in any setting, and not limited to the setting right before the power turned off. Further, it was explained above that the television receiver automatically transitions to the exhibition mode. However, the television receiver may be designed to manually transition to the exhibition mode. Meanwhile, the television receiver may be designed such that the exhibition mode can be cancelled manually. Therefore, an adjustment may be made by the consumer him or herself changing the setting even in a case when the television receiver of a purchaser is accidentally transitioned to the exhibition mode.

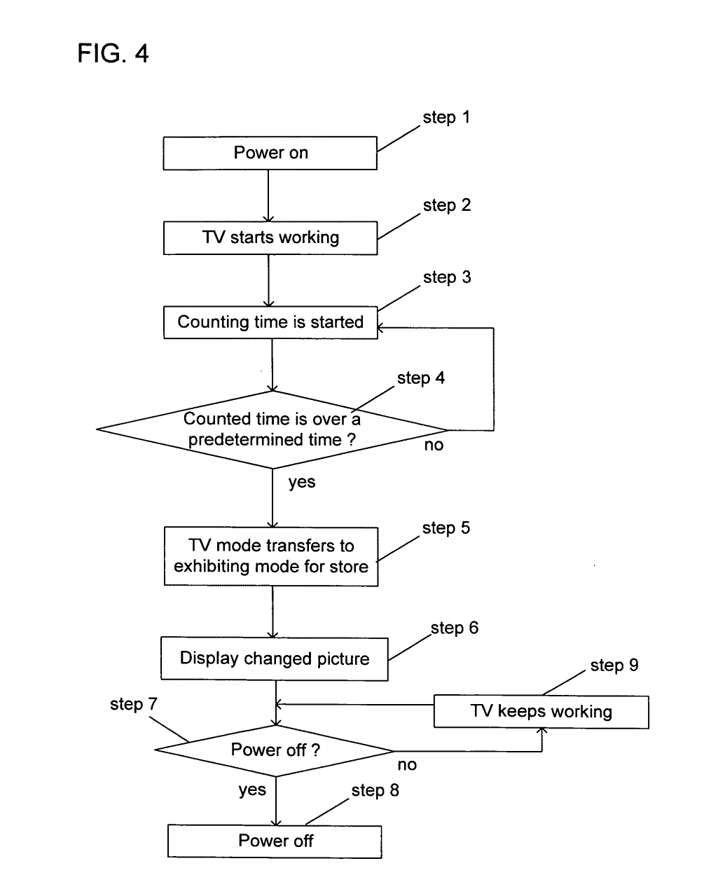

Next, the operation patterns for the television receiver pertaining to the present invention will be concretely explained according to FIGS. 4 to 6. FIG. 4 is a flow chart illustrates an example of operation pattern of the television receiver pertaining to the present invention. First, when the power of the television receiver is turned on (step 1), the television receiver starts an operation (step 2). When the television receiver starts the operation, a counter provided in the television receiver starts measuring time (step 3). The measured time may be stored in a memory sequentially. Next, a judgment unit determines whether the measured time exceeds a predetermined time or not (step 4).

In a case when the measured time exceeds the predetermined time, a controller converts the mode of the television receiver to a mode suitable for exhibition (step 5). In a case when the measured time does not exceed the predetermined time, the measurement of the time by the counter continues. When the mode of the television receiver converted to the mode suitable for exhibition, a picture is shown on a display with the converted mode (step 6). After the picture is shown on the display, a determination is made as to whether there is an instruction to turn off the power of the television receiver or not (step 7).

In a case when there is the instruction to turn off the power, the power of television receiver is turned off and the television receiver stops operation (step 8). When there is no instruction to turn off the power, the television receiver continues showing the picture on the display (step 9). In addition, while determining whether there is the instruction to turn off the power, the television receiver may, as a matter of course, receive an instruction signal, such as changing a channel, by the remote control transmitted 23. Meanwhile, in a case when the power consumption is the subject that the counter measures, the television receiver can operate the same process as shown in FIG. 4.

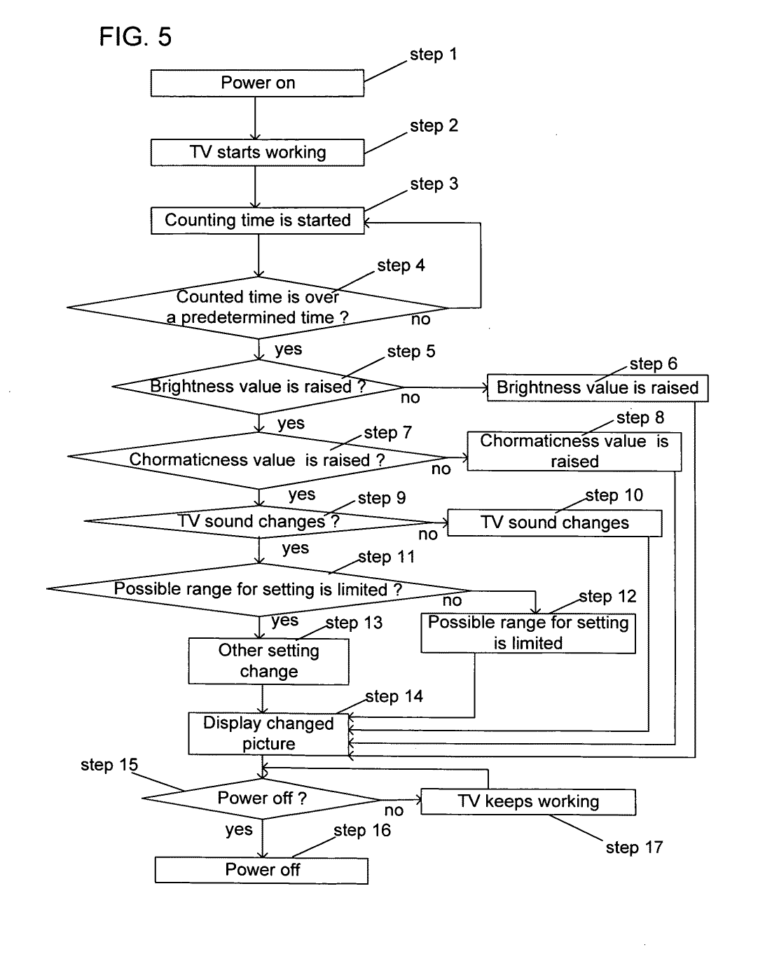

Next, FIG. 5 will be hereinafter explained. FIG. 5 is a flow chart illustrates an example of an operation pattern of the television receiver pertaining to the present invention. FIG. 5 lists the exhibition modes that can be provided in the television receiver pertaining to the present invention and is a chart illustrating the operation patterns of these modes. In FIG. 5, the television receiver operates steps 1 to 4 the same as in the FIG. 4. When the measured time by the counter is determined to be exceeding the predetermined time in the step 4, the operation for setting the television receiver to an exhibition mode is automatically started. Concretely, a determination is made as to whether the setting is changed to the exhibition mode by increasing the brightness of the picture or not (step 5). The brightness of the picture is increased when the brightness unit determines that the setting is changed to the exhibition mode (step 6). The brightness may be set at the value described above. When it is determined that the setting is changed to the exhibition mode other than the brightness unit, a determination is made as to whether the setting is changed to the exhibition mode by increasing the color saturation (step 7).

When the color saturation unit determines to perform transition to the exhibition mode, the color saturation value of the picture is increased (step 8). When the determination is made that the unit other than the color saturation of the picture transition to the exhibition mode, a determination is made as to whether the mode is shifted to the exhibition mode by adjusting the sound level or not (step 9). When it is determined that the adjustment of the sound level is changed to the exhibition mode, the sound level of the television receiver is adjusted (step 10). When it is determined that the unit other than the sound level transitions to the exhibition mode, a determination is made as to whether the transition to the exhibition mode is made by limiting a setting range of the television receiver within which a setting of the television receiver can be changed or not (step 11). When it is determined that the transition to the exhibition mode is made by limiting the setting range within which a setting of the television receiver, the range is limited (step 12).

When it is determined that the transition to the exhibition mode is made by the means other than limiting the range, finally the mode of the television receiver is shifted to the exhibition mode by changing the setting related to the television receiver other than those described above (step 13). As a result of the transition to the exhibition mode that is made by some sort of means with the above mentioned operation to the television receiver, picture is started to be provided (step 14). After the picture is displayed, a determination is made as to whether there is an instruction to turn off the power of the television receiver (step 15). When there is the instruction to turn off the power, the television receiver stops operation (step 16). When there is no instruction to turn off the power, the television receiver continues to display the picture on the display (step 17).

In addition, the process to shift the mode of the television receiver to the exhibition mode is not necessarily formed only from the steps 5 to 13 described above. Further, a process, such as a process for determining whether the mode is to be shifted into an anti-theft setting, may be included. Further, the television receiver pertaining to the present invention may not include all of the transition processes to the exhibition mode as shown in FIG. 5, and may have a design that some processes are omitted. Still further, the means to be selected is not limited to one when shifting to the mode of television receiver into the exhibition mode, and a plurality of means may be used to shift the mode of the television receiver to the exhibition mode. For example, a television receiver with an exhibition mode in which an antitheft setting has been set and the brightness of the picture has been increased, can be designed.

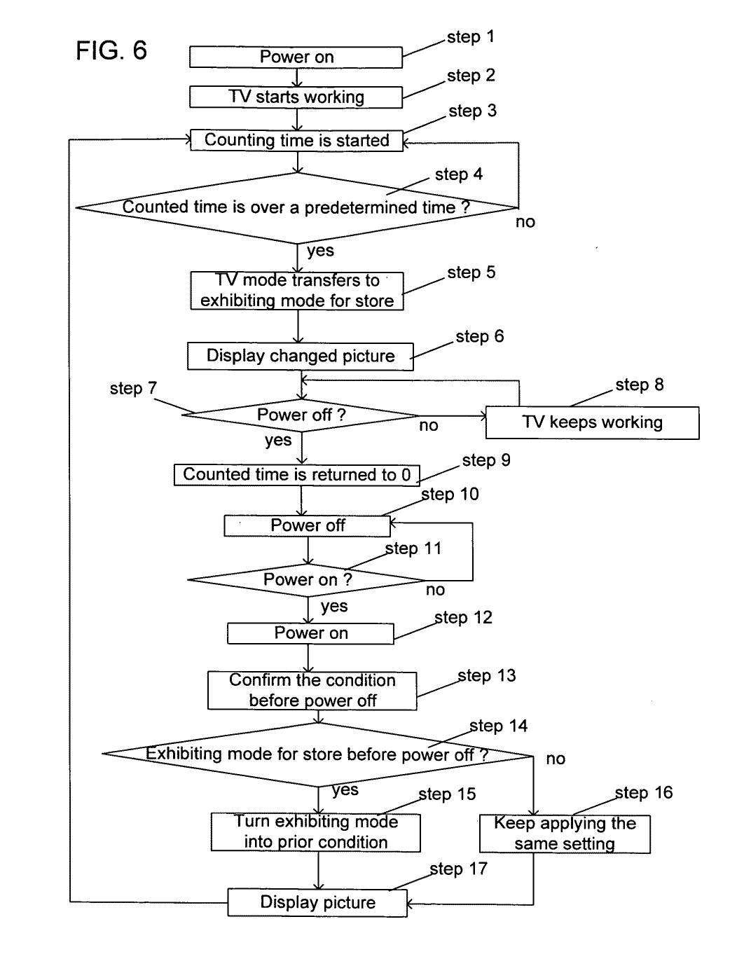

Next, FIG. 6 will be explained. FIG. 6 is a flowchart illustrating an example of an operation pattern of the television receiver pertaining to the present invention. FIG. 6 illustrates an operation pattern of the television receiver capable of starting operation with a normal setting when the television receiver is turned back on after the power of the television receiver in the exhibition mode is turned off. This is a chart in which assuming a case where a purchaser of a television receiver accidentally brings the television receiver with an exhibition mode to his or her home.

In FIG. 6, the television receiver operates the same as FIG. 4 for the steps 1 to 8. When a determination is made to turn off the power of the television receiver in step 9, the time measured by the counter is reset to 0 (step 9). Thereafter, the power of the television receiver is turned off (step 10). Thereafter, a determination is made as to whether the power of the television receiver is turned on or not (step 11). The television receiver continues to stop the operation when there is no instruction to turn on the power of the television receiver (step 10). Meanwhile, the power is turned on when there is an instruction to turn on the power of the television receiver (step 12).

When the power is turned on, firstly, setting condition of the television receiver before turning off the power is confirmed (step 13). As a result of the confirmation, a determination is made as to whether the setting condition before the power off is the exhibition mode or not (step 14). When the setting condition before turning off the power is the exhibition mode, the exhibition mode is returned to a normal mode to be used in a household etc (step 15). When the setting condition before turning off the power is determined be not the exhibition mode, the setting which is not the exhibition mode is continued (step 16). After having been set to the normal mode in the step 15 or 16, the television receiver finally starts to provide a picture (step 17). And, the television receiver starts to measure time after having started to provide the picture or at the same time of providing the picture (step 3).

In addition, the exhibition mode is returned to the normal mode used in a household at the step 15 in the operation pattern of FIG. 6. However, this normal mode may be any setting. For example, the normal mode may be the setting of the television receiver right before being shifted to the exhibition mode. Further, the setting of the television receiver may be the setting of two or more steps before being shifted to the exhibition mode. Meanwhile, the mode continued in the step 16 may be any mode other than the exhibition mode, and for example, the setting includes not only the setting of the television receiver right before turning the power off but also any setting applied at any timing.

Further, the start of time measuring in step 3 may be set before the television receiver provides the picture. Also, step 9 may be omitted in the process of FIG. 6. That is, for example, the measured time is not reset and stored in a memory, or the measurement may be continued. Further, the television receiver may be designed such that the setting data is stored in the memory and it can be used as needed even after the setting of the television receiver is changed.

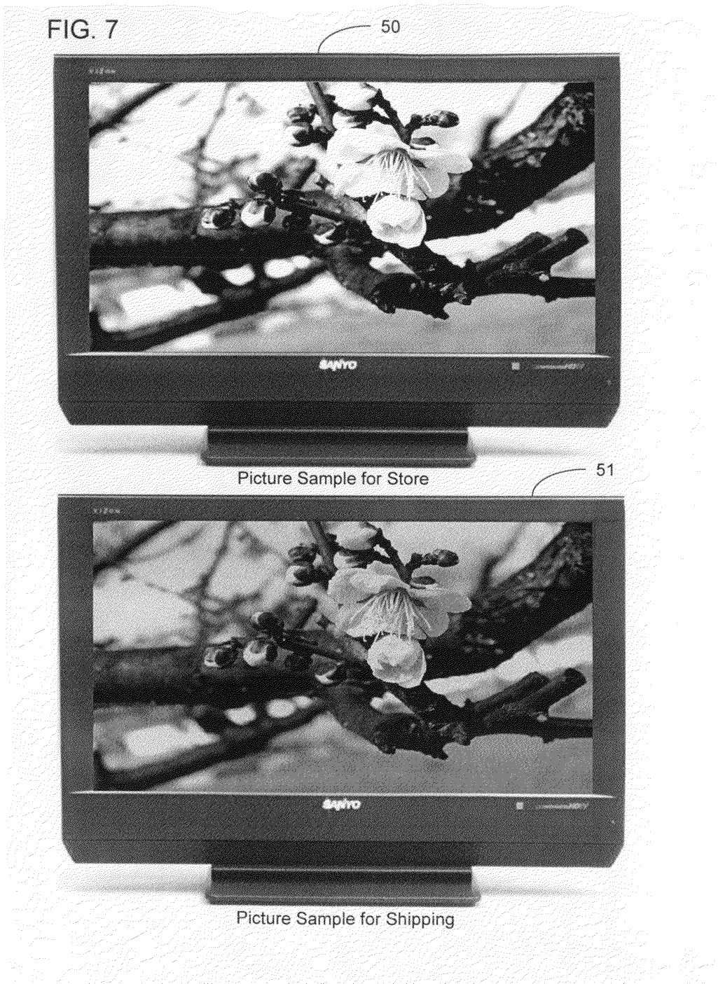

FIG. 7 is a diagram comparing the television receiver set to a mode suitable for storefront exhibition, and a television receiver at shipping. Two television receivers are shown in FIG. 7. The television receiver 50 shown on the upper side of the figure is set to the mode for storefront exhibition, thus the display is set in very bright. Meanwhile, the television receiver 51 shown on the bottom of the figure is in a normal mode used in a household etc., the display is set to a little darker comparing to the television receiver 50. When the television receiver is exhibited in a storefront, the display is set sufficiently bright as shown in the figure. Therefore, a clear picture can be provided to consumers etc. even in a case when a television receiver is installed in a place of a relatively large area.

The present invention has been explained concretely using the plurality of the drawings and flowcharts. Needless to say, the present invention is not limited to those and no matter how the present invention is carried out, it falls within the technical scope of the present invention as long as the product includes the essential part of the present invention. For example, application of the exhibition mode of the present invention is not limited to the television receivers, and the exhibition mode may be applied to other electronic products, such as, a camera, personal computer, video devices, video game device, cellular phone, watch, CD, DVD, personal computer peripheral devices, electronic products with a display (e.g. car navigation system) etc. In addition, the features pertaining to the present invention described above are the conditions particularly suitable for handling a liquid crystal television (brightness value, power consumption etc.). However, the conditions may be applied to a television and electronic products having different configurations.

What is claimed is:

1. A television receiver, comprising:
a counter, which measures a time period for which the television receiver continuously operates;
an evaluator, which determines whether the time period is more than a predetermined time period; and
a controller, which adjusts a brightness value of a picture to more than a predetermined value when the time period is more than the predetermined time period.

2. A television receiver of claim 1, wherein the brightness value is adjusted to not less than 450 cd/m² when a size of the television receiver is not less than 24 inch.

3. A television receiver of claim 1, wherein the brightness value is adjusted to not less than 250 cd/m² when a size of the television receiver is less than 24 inch.

4. A television receiver of claim 1, wherein the brightness value of the picture is adjusted to a brightness value, which is suitable for an exhibition.

5. A television receiver of claim 1, further comprising:
a liquid crystal display having a backlighting device,
wherein a on-mode power level of the backlighting device is not more than 391 W when a size of the liquid crystal display is not more than 60 inches.

6. A television receiver of claim 4, the backlighting device is a light emitting diode or a cold cathode fluorescent lamp.

7. A television receiver of claim 1, wherein the counter starts measuring the time period when the television receiver is turned on and stops measuring the time period when the television receiver is turned off.

8. A television receiver of claim 1, wherein the counter resets the time period when the television receiver is turned off.

9. A television receiver of claim 1, wherein the predetermined time period is 48 hours.

10. A television receiver of claim 1, wherein the predetermined time is 36 hours.

11. A television receiver, comprising:
a measuring device, which counts a power consumption of the television receiver while the television receiver continuously operates; and
an adjuster, which automatically raises a brightness value of a picture when the power consumption is more than a predetermined value.

12. A television receiver of claim 11, wherein the adjuster converts a condition of the television receiver into a condition which is suitable for an exhibition.

13. A television receiver of claim 12, wherein the adjuster converts a sound level of the television receiver into a sound level which is suitable for exhibition condition.

14. A television receiver of claim 12, wherein the adjuster limits a setting range of the television receiver within which a setting of the television receiver can be changed.

15. A method of adjusting a setting of a television receiver, comprising the steps of
counting a time period within which the television receiver is continuously turned on; and
determining whether a brightness value of a picture is suitable or not according to the time period.

16. A method of claim 15, wherein the brightness value resumes to a setting condition prior to the step of adjusting when the television receiver is turned on again after being turned off.

17. A method of claim 15, wherein the number of possible items for adjusting setting of the television including the brightness value is limited once the brightness value has been adjusted.

18. A method of claim 15, wherein the brightness value automatically resumes to a setting condition in which the brightness value was adjusted when the brightness value is changed after having determined that the brightness value has been adjusted.

19. A method of claim 15, wherein the brightness value is adjusted to not less than 450 cd/m² when a size of the television receiver is not less than 24 inches.

20. A method of claim 15, wherein the brightness value is adjusted to not less than 250 cd/m² when a size of the television receiver is less than 24 inches.
